(19) United States
(12) Patent Application Publication
(10) Pub. No.: US 2023/0342670 A1
(43) Pub. Date: Oct. 26, 2023

(54) TASK-SPECIFIC MACHINE LEARNING OPERATIONS USING TRAINING DATA GENERATED BY GENERAL PURPOSE MODELS

(71) Applicant: Nvidia Corporation, Santa Clara, CA (US)

(72) Inventors: Ryan Leary, Woodstock, GA (US); Jonathan Cohen, Mountain View, CA (US)

(21) Appl. No.: 17/727,332

(22) Filed: Apr. 22, 2022

(51) Int. Cl. G06N 20/20; G06F 16/953; G06F 16/906

(52) U.S. Cl. CPC G06N 20/20; G06F 16/953; G06F 16/906

(57) ABSTRACT

Systems and methods provide a pipeline to develop and deploy machine learning models by using query/response pairs from a different machine learning model as training data. A set of model parameters are established and a trained machine learning models provides responses to input queries to develop query/response pairs. These query/response pairs may be used to train a different machine learning model. That model can be tested against the original model to determine whether they are in agreement, and when the models are in agreement the different machine learning model can be deployed as the primary model for the system.

### BACKGROUND

Various systems may deploy machine learning models to interact with input queries. Typically, these models are trained on large datasets or on human-annotated datasets for specific tasks or domains. Obtaining sufficiently large datasets or human-annotated datasets may be time consuming and expensive, which may delay deployment of models. Moreover, using general purpose models for specific applications may lead to poor results, which may be exacerbated when expected user queries are specific to a particular domain that the models may not be sufficiently train on.

### BRIEF DESCRIPTION OF THE DRAWINGS

Various embodiments in accordance with the present disclosure will be described with reference to the drawings, in which:

FIG. 1 illustrates an example natural language processing environment, according to at least one embodiment;

FIG. 2 illustrates an example of a machine learning platform, according to at least one embodiment;

FIG. 3 illustrates an example of a machine learning platform training stage, according to at least one embodiment;

FIG. 4 illustrates an example of a machine learning platform verification stage, according to at least one embodiment;

FIG. 5 illustrates an example of machine learning platform production stage, according to at least one embodiment;

FIG. 6A illustrates an example flow chart of a process for generating training data, according to at least one embodiment;

FIG. 6B illustrates an example flow chart of a process for verifying a machine learning model, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

Approaches in accordance with various embodiments provide systems and methods for automated model development. In at least one embodiment, training data for a task specific model may be generated by a general purpose model, such as a zero-shot model. For example, an initial environment may be deployed using a zero-shot model and the responses from the zero-shot model may be saved, along with their associated input queries, in order to generate training data for the task specific model. Over time, both the task specific model and the zero-shot model may be deployed to determine a convergence between the two, where a threshold level of convergence may lead a transition to exclusive or semi-exclusive use of the task specific model. In this manner, lighter, less computational intensive models may be rapidly developed and deployed by leveraging benefits of more sophisticated, more computationally intensive models.

In at least one embodiment, a zero-shot approach may be utilized with a general purpose model in order to receive a user input and provide a response. The zero-shot approach may be utilized for recognition of user intents, for example based a user input, such as an auditory input. Various embodiments may include one or more trained neural network models that receive an input, such as an auditory user query, and determine a label for the associated input that corresponds to an intent of the query. The label may be determined based, at least in part, on a probability the label corresponding to the intent exceeds a threshold. In at least one embodiment, a set of pre-determined labels may be provided, where user inputs are then evaluated against those labels to determine which label is most likely associated with the input.

Various embodiments may overcome problems associated with deploying natural language processing (NLP) and/or understanding (NLU) technologies. The process of curating, preprocessing, and labeling training data to bring it into a form suitable for training a model can be arduous, time-consuming, and expensive. Traditional NPL models take too long to bootstrap (e.g., time from concept to a deployed system). While a general purpose model, such as a zero-shot model, can reduce deployment time, it may be difficult to obtain quality results with very large inference routines, which may be prohibitively expensive or too computationally intensive to run when compared to, for example, a task-specific model trained in a supervised fashion. Accordingly, various embodiments provide systems and methods that allow hybrid models to develop language models that can be deployed quickly without the drawbacks of requiring large initial datasets or the expensive of continuously operating zero-shot models. Various systems determine (e.g., based on user input) a relevant domain or class and then deploy a model corresponding to the domain using a general purpose zero-shot model for inference requests. Requests provided to the general purpose model, and subsequent answers, are then recorded and used as ground truth training data for a task-specific model. Once training is complete, or reaches a threshold level, answers from both models may be compared to assess a level of agreement, where if sufficient agreement is reached, queries may be directed toward the task-specific model, thereby realizing significant computational savings. Moreover, due to a reduced size of the task specific model, deployment of the models may be extended to additional or previously infeasible applications or computing environments, such as enabling edge inferencing, among other options.

Various embodiments may further provide a dashboard of environment to allow a user to enter various specifications for generation of new models. For example a user may select a domain for a particular model and then provide various labels or information to assist in establishing the general purpose zero-shot model. However, it should be appreciated that labels may also be produced by the model to be validated and/or corrected, among other options. Furthermore, various embodiments may facilitate active learning to raise low-confidence labels for review, which may further enable improvements to the model. In at least one embodiment, manual corrections or additional inference usage can trigger new model training, for example if one or more thresholds are met. When new models are trained, evaluation (which may incorporate manually corrected data or zero-shot-produced labels) may be performed in order to ensure no regression, and score calibration may be performed to ensure consistent confidence scores across model versions. It should be appreciated that the dashboard may enable a user to trigger model compression either via distillation and/or quantization, depending on target use cases (e.g., deployment on an edge server, embedded devices, etc.).

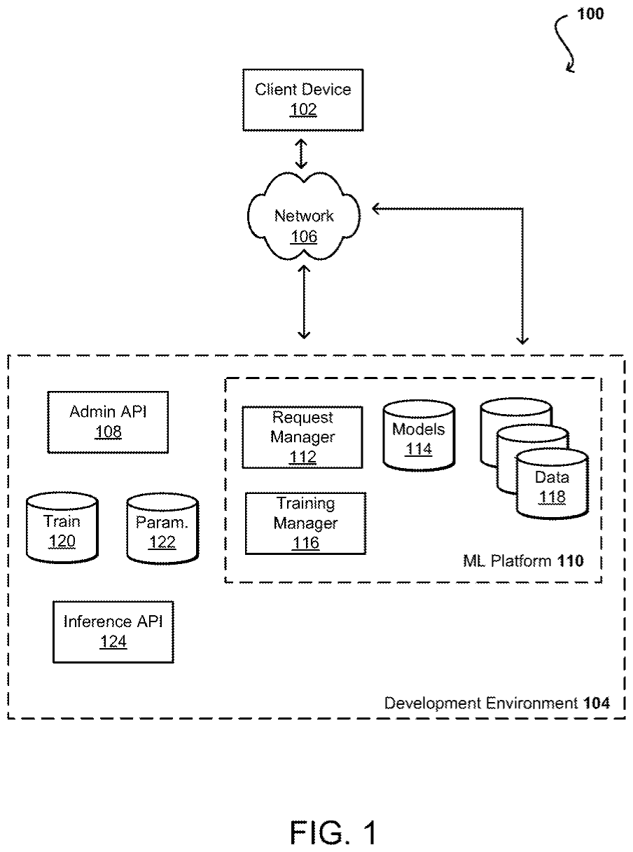

An environment 100 may be utilized with one or more NLP/NLU systems in order to develop models, as shown in FIG. 1. It should be appreciated that the environment 100 may include more or fewer components and that various components of the environment 100 may be incorporated into singular systems, but may be shown as separate modules for convenience and clarity. In this example, a client device 102 may make one or more requests to a development environment 104 via one or more networks 106. The networks 106 may be wired or wireless networks which include one or more intermediate systems, such as user devices, server components, switches, and the like.

In this example, the development environment 104 may be associated with a platform that may offer one or more hosting or compute services for users, among other options. For example, the development environment 104 may enable a user to leverage one or more machine learning systems, such as conversational artificial intelligence (AI) systems, for integrated use with one or more of their products. The development environment 104 may enable the user to develop their own models for their desired purposes, to leverage existing models, or combinations thereof. Furthermore, the development environment 104 may also provide services such as model training, model verification, and the like. It should be appreciated that the development environment 104 may be integrated into a larger service environment which may provide various one-time or subscription based services to users. Furthermore, the development environment 104 may be associated with one or more software development toolkits (SDKs) to build applications for specific platforms.

Illustrated within the development environment 104 is administrator API 108 that may receive one or more requests submitted by the client device 102. The administrator API 108 may provide an interface for the client device 102 to interact with, such as to submit requests for new machine learning systems, to edit or adjust properties of existing machine learning systems, to run diagnostics, and the like. In at least one embodiment, the administrator API 108 may be associated with a service provided to the client device 102 associated with hosting and/or operation of machine learning systems, among other options.

In at least one embodiment, a machine learning platform 110 is associated with the development environment 104. The machine learning platform 110 may include one or more tools to enable users to establish, train, and/or operate various machine learning systems for a variety of applications. For example, users may leverage existing models, such as a general purpose model that has trained on a large data set, and then fine tune or otherwise train the model for a task specific operation. A request manager 112 may receive requests, such as from the administrator API 108 to adjust to select a model, or from the client device 102 to execute one or more operations using an established model. The request manager 112 may select one or more models from model database 114. The model database 114 may include a set of general purpose models and/or task specific models. In at least one embodiment, previously trained and developed models associated with the user may be stored in the model database 114 for later access and/or changes. For example, a user may have a variety of different models for different applications and different models may be accessed and used at different time.

The machine learning platform 110 may also be utilized to develop new models. For example, one or more models, such as a general purpose model from the model database 114, may go through a training process where a training manager 116 selects data 118 to train the model. For example, the training manager 116 may select one or more datasets related to a task specific application. Additionally, in at least one embodiment, the training manager 116 may select how many training passes are made, parameters associated with training, and the like.

In at least one embodiment, users may provide training data for use with training operations, which may be stored in a database 120. For example, the user may bring their own datasets or may generate new datasets through saving different operations associated with one or more models. The database 120 may be utilized for task specific training of one or more models. Furthermore, users may provide parameters 122 for storage and use by the training manager 116 and/or the request manager 112 when establishing or using a model. The parameters 122 may include specific classes associated with models, desired accuracy levels, latency, and the like.

In operation, user requests may take the form of an input query, such as a question for a conversational system, that may interact with an interference API 124. The inference API may interface with the machine learning platform 110, such as to present questions for evaluation and then provide answers back to the user.

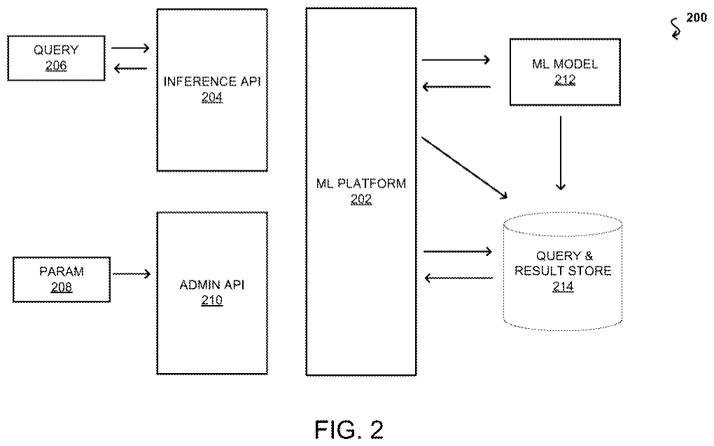

FIG. 2 illustrates an environment 200 where a machine learning platform 202 may be queried via an inference API 204 to provide responses to one or more input queries 206. In this example, one or more users or user devices may generate input queries 206 that are associated with one or more machine learning models. In at least one embodiment, the model is a model generated and developed in accordance with one or more parameters 208 that are provided to an administration API 210. For example, a developer may provide different model parameters, such as desired classes, to the administration API 210 to be developed into a specific machine learning model.

As noted above, task specific models may be challenging to train and deploy due to a lack of sufficient training data. However, these types of models may be trained with traditional supervised training methods and, as a result, may be less computationally intensive and also smaller. In contrast, general purpose models, such as zero shot models, may be trained on large data sets, but may not have sufficient information for one or more particular tasks associated with a task specific model. Accordingly, embodiments of the present disclosure may utilize one or more machine learning models 212 to generate responses to the queries 206 and then use those responses, along with the queries 206, in order to develop training data for use with training one or more general purpose models. In this manner, new models may be quickly deployed and then, over time, larger, more computationally intensive general purpose models may be replaced with the trained task specific models.

In this example, the machine learning models 212 are zero shot classifiers. In at least one embodiment, a zero shot model includes a user-defined set of classes (e.g., intents) and labels for those classes (e.g., intent labels). By way of example, an intent for a restaurant application may be to purchase a hamburger, with the associated label being related to buying a hamburger. Each of these classes may have a corresponding question or follow on action, which may then be used to select a value to fill a slot. As an example, a class may relate to a desire to purchase a hamburger and the values to fill that slot (e.g., determine a follow on action) could be to add a number of hamburgers to a shopping cart to complete an order.

The machine learning models 212 may generate responses to the queries 206 to the machine learning platform 202 to be provided back to the user. Additionally, the machine learning models 212 may transmit the responses to a query and result store 214 to be stored with their associated queries 206. That is, the machine learning platform 202 may transmit queries to be stored along with responses to those queries, thereby generating a set of training data for different sets of queries and responses. The set of training data stored in the query and result store 214 will be application specific because it will be queries and responses associated with the input parameters 208 for the particular system. Moreover, the set of data will grow over time with use of the model 212.

In operation, an administrator associated with a user or provider may interact with the administration API 210 in order to provide various parameters 208 for development and deployment of one or more new machine learning systems, such as conversational AI systems, among other options. The parameters 208 may, in at least one embodiment, include user defined classes that are associated with one or more zero shot models, such as the model 212. The model 212 may then be associated with a machine learning platform 202 that may be receive queries 206 through an inference API 204. The model 212, which as noted above may be a general purpose model, may provide responses to the queries 206, while those responses and their associated queries are saved. For example, inference requests (e.g., queries 206) are received and labels are looked up for the model, where the labels may form a part of the parameters 208. In at least one embodiment, zero shot classification is performed in order to generate responses to the requests. As will be described herein, once a threshold number of responses and queries are stored within the query and result store 214 or a threshold period of time has elapsed, the information within the query and result store 214 may be used, at least in part, to train a smaller, lighter task specific model for use with the machine learning platform 202.

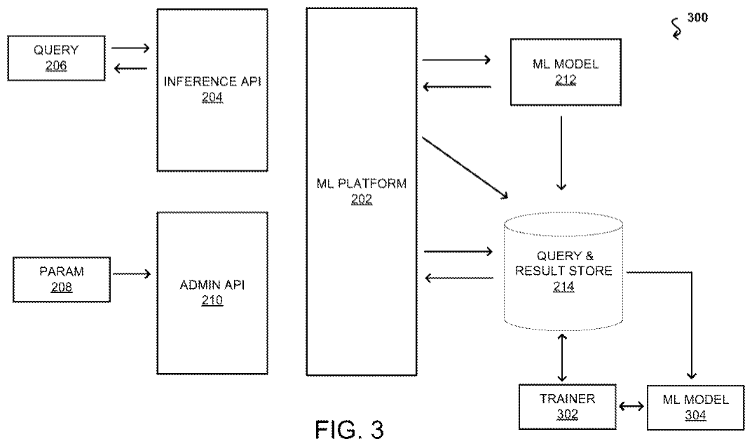

FIG. 3 illustrates an environment 300 operating in a learning stage where a trainer 302 may be triggered to begin or to schedule training for a second machine learning model 304. As noted above, various embodiments provide for the machine learning platform 202 to be queried via the inference API 204 to provide responses to one or more input queries 206. These input queries 206, and their associated responses, are stored within the query and result store 214 to be used as training data to train one or more second machine learning models 304, which may be different from the machine learning model 212. For example, the second machine learning models 304 may be lighter weight models that are trained for a specific purpose, such as for the specific parameters 208, and may also be referred to as task specific models. Utilizing the second machine learning models 304, after training, may provide the functionality expected for the environment while also reducing computational costs. Furthermore, using lighter models may enable deployment and operation on devices with smaller computational capabilities, thereby providing edge deployments and an increased range of functionality.

In this example, queries 206 are submitted over a period of time, with the machine learning model 212 generating responses to these queries 206. During this time, the query and result store 214 may be receiving the queries 206 and associated responses to those queries to develop a training data set, which may be utilized to train one or more machine learning systems as ground truth data. It should be appreciated that this data set may be modified or otherwise adjusted based, at least in part, on user reactions to the responses provided by the queries. By way of example only, one of the classes or labels associated with the initial parameters 208 may be to report an error. Accordingly, a query/response pair that is followed by error reporting may be flagged or otherwise not provided to the query and result store 214. In this manner, flagged responses may receive lower weights during training or may be eliminated from training.

The trainer 302 may be utilized to train the second machine learning model 304 and may also act as a scheduler to determine when to begin and/or start training. In at least one embodiment, training is started when a threshold number of query/response pairs are stored in the query and result store 214. Additionally, in embodiments, the training may be started after a period of time has elapsed. Furthermore, it should be appreciated that multiple training sessions may be instituted, such that training may begin over a first set of data and then further training begins when a second set of data is received. In this manner, the second machine learning model 304 may be trained iteratively or in stages. It should be appreciated that different data sets may be combined during the training of the second machine learning model 304. For example, over a first period of time the query and result store 214 may have 1,000 query/result pairs. Training may begin on these 1,000 pairs. Over a second period of time, an additional 500 query/result pairs may be stored in the query and result store 214. For the second training phrase, all 1,500 query/result pairs may be used, only the new 500 query/result pairs may be used, or any combination thereof may be utilized for further training and refinement of the second machine learning model 304. In at least one embodiment, training may commence in a scheduled manner or may be performed using spare compute capacity in between inference requests. In various embodiments, the second machine learning model 304 may be a supervised text classifier model that is specifically trained on the classes associated with the parameters 208. For example, one or more embodiments may include models that include an encoder module, such as a pre-trained BERT-like model, and a decoder module, such as a multi-layer perceptron classifier.

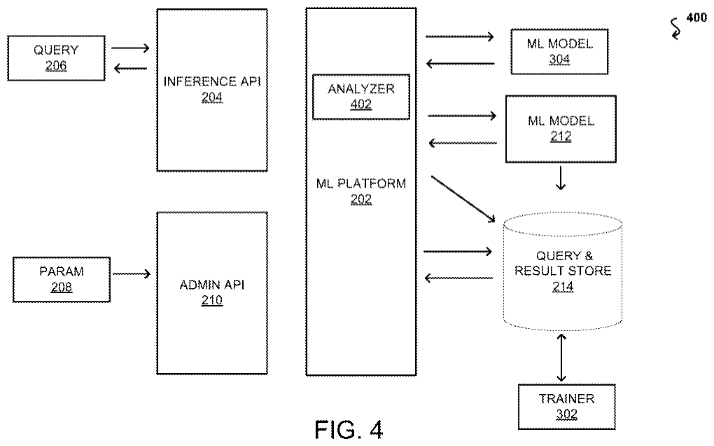

FIG. 4 illustrates an environment 400 operating in a validation stage where the second machine learning model 304 operates along side the machine learning model 212. In this example, queries 206 are provided to both the first and second machine learning models 212, 304, which then may generate responses to the queries 206 and provide the responses to the machine learning platform 202 and/or to an analyzer or determination component 402 associated with the machine learning platform 202. The analyzer 402 validates agreement between the respective responses generated by the machine learning model 212 and the second machine learning model 304. For example, the analyzer 402 may determine whether a threshold level of agreement is reached between the two models 212, 304, where a threshold level of agreement may correspond to a percentage of agreed responses, a correlation between individual responses, or others. By way of example only, if the query 206 is “I need a vanilla milkshake” and the machine learning model 212 identifies this label or intent as corresponding to “related to buying a drink” and the second machine learning model 304 also identifies the label or intent behind the query as “related to buying a drink,” then agreement may be considered high or satisfied. However, if the second machine learning model 304 identifies the label or intent behind the query as “related to buying a hamburger,” it may be determined that additional training may be required if there is not agreement with a threshold number of responses.

In at least one embodiment, both models process requests during the validation stage to assess the level of agreement of predictions between the machine learning model 212 and the second machine learning model 304. The validation stage may operate for a given period of time, such as a number of requests or a certain time frame, and then a decision may be made whether to retrain the second machine learning model 304 or not. If sufficient agreement between the model exists, the system may pivot or otherwise stop providing queries 206 to the machine learning model 212 in favor of the second machine learning model 304, thereby realizing significant computational savings. Furthermore, due to reduced complexity and computational intensity, the second machine learning model 304 may also be suitable for edge inference.

It should be appreciated that while systems and methods may be described where both the models 212, 304 are operating at the same time or substantially the same time (e.g., in parallel or at least partially in parallel), various embodiments may not necessarily operate using such an approach. For example, the machine learning model 212 may be deployed to capture data that is fed into the query and result store 214. Then, offline, at a later time, the second machine learning model 214 may be trained. Thereafter, agreement (alignment) could also be analyzed offline prior to deployment of the second machine learning model 214. By way of example, after training the second machine learning model 214, a set of queries 206 may be saved for evaluation and comparison. The query/result pairs from the machine learning model 212 may then be compared to subsequent query/result pairs from the second machine learning model 304. If sufficient agreement (alignment) is reached, the second machine learning model 304 may be deployed. Accordingly, while embodiments may discuss the parallel or semi-parallel operation of the models 212, 304, it should be appreciated that training and/or validation may be performed at any time prior to full deployment of the second machine learning model 304.

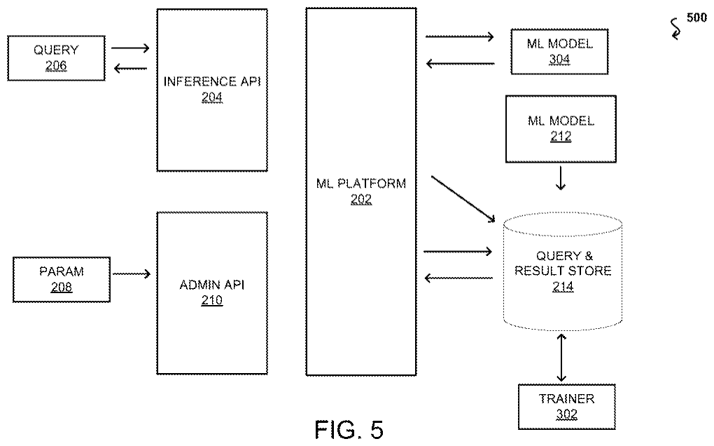

FIG. 5 illustrates an environment 500 operating in a production stage where the second machine learning model 304 provides responses to inference requests and the queries 206 are no longer provided to the machine learning model 212. In this example, it is determined that the second machine learning model 304 is sufficiently trained (e.g., has reached a threshold level of agreement with the machine learning model 212) to begin operation. As noted above, in at least one embodiment, the second machine learning model 304 may operate in parallel or substantially in parallel with the machine learning model 212 prior to entering production stage. In at least one embodiment, the second machine learning model 304 will be pre-trained and tested prior to deployment without operation along with the machine learning model 212.

In various embodiments, query/response pairs from the second machine learning model 304 are stored within the query and result store 214. This information may be stored for continued training or re-training of the second machine learning model 304 and/or the machine learning model 212. Moreover, the query/response pairs may be periodically tested for drift or errors, which may prompt re-training or periodic operation of the machine learning model 212 while the second machine learning model 304 is tuned.

Various embodiments of the present disclosure enable an operator, via the administrator API 210, to quickly define and deploy new machine learning models. Furthermore, the operator may continue to monitor or otherwise supervise operation of the models 214, 304. For example, the operator may manually validate or correct various. Additionally, active learning may be leveraged to raise low-confidence labels for review, thereby potentially increasing their impact on the model and subsequent improvements to the model. Furthermore, operators may also make manual corrections or add additional inference API usage to trigger new model training.

In at least one embodiment, model training may also be evaluated and monitored, such as via an operator or one or more established rules or procedures. For example, when new models are trained, one or more operations may be triggered to evaluate the models, which may include evaluating using manually corrected data, to ensure no regression has occurred. Score calibration may be performed to ensure consistent confidence scores across model versions.

As previously indicated, in at least one embodiment, the second machine learning model 304 may be configured to operate on systems with less computational power, such as on an edge server, embedded device, etc. Systems and methods may provide for compression (e.g., via distillation or quantization) depending, at least in part, on the use case. Accordingly, a larger array of devices may benefit from the second machine learning model 304.

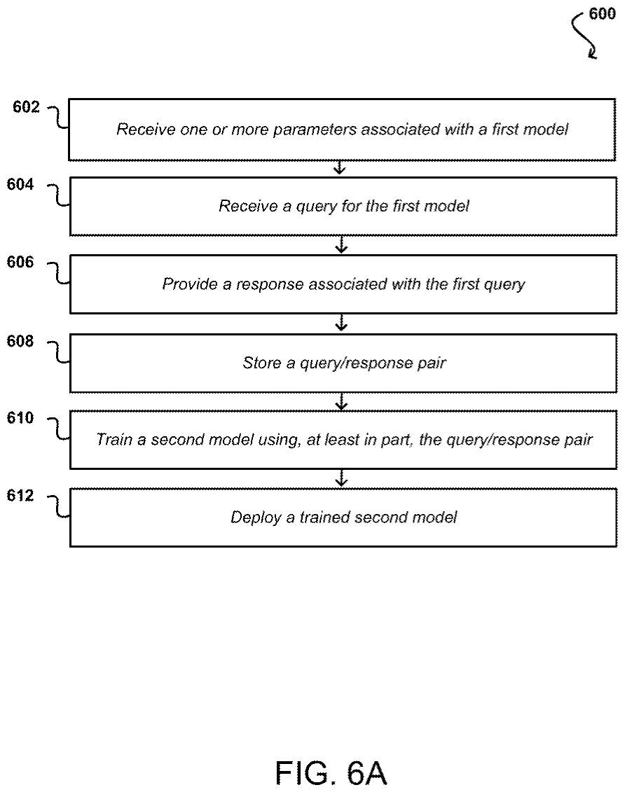

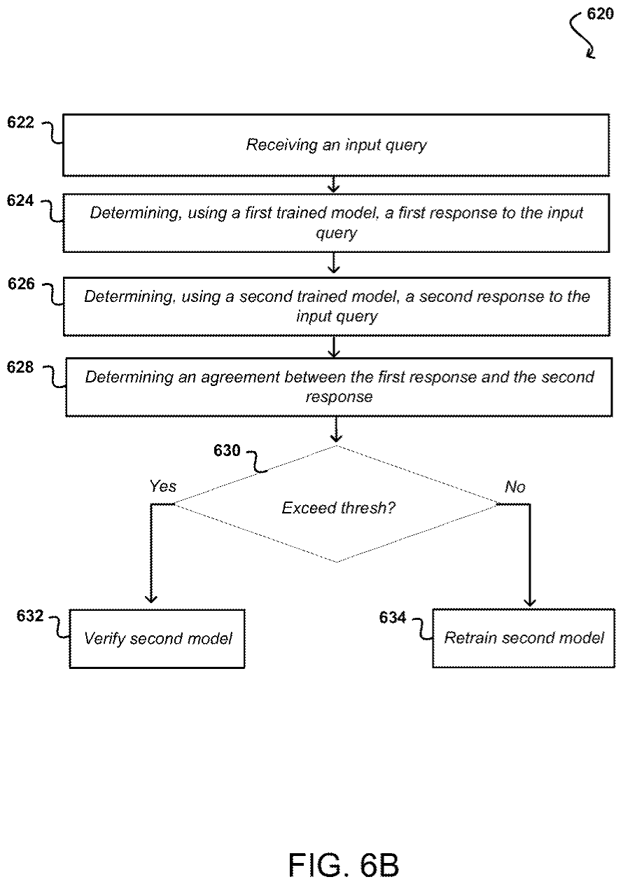

FIG. 6A illustrates an example process 600 for generating training data using a first machine learning model. It should be understood that for this and other processes presented herein that there can be additional, fewer, or alternative steps performed in similar or alternative order, or at least partially in parallel, within the scope of various embodiments unless otherwise specifically stated. In this example, one or more parameters associated with a first model are received 602. The parameters may be directed toward a desired set of classes and/or labels associated with the first model, which may be provided through an API that enables an operator to establish new machine learning models, such as conversational AI models, among others. The parameters may include a variety of settings for the model, such as the above-referenced classes, latency limits, size limits, and the like. Moreover, in at least one embodiment, the parameters may specify one or more types of models to deploy.

Various embodiments provide an interface to enable the first model to receive one or more input queries 604. The first model may be a pre-trained model, such as a general purpose model, which may further be a zero shot model. The zero shot model may receive a query, which may be directed toward one or more classes with an associated label. While the first model may not be specifically trained on the classes, the input parameters may include some class/label designations to enable classification of the queries to identify the appropriate labels, and in various embodiments, subsequent responses or actions associated with these labels. A response may then be provided to the first query 606. The response may be an action, such as performing a requested task, or may be a response to a question, among various other options. The query/response pair may be stored to a database 608. For example, one or more portions of the query/response may be stored, including the class, label, action, response, etc.

In at least one embodiment, information from the database is used to train a second model, which may be a task specific model 610. The information may include the query/response pairs, which may provide a class specific level of training for the second model without manually generating a dataset. After the second model is trained, it may be deployed in place of the first model 612. In this manner, training data may be developed using a larger, more complex model and then replaced with a task specific model that is trained on the information acquired during operation of the first model.

FIG. 6B illustrates an example process 620 for verifying a task specific model. In this example, an input query is received 622. For example, the input query may be provided to an interference API that may interact with one or more machine learning platforms. A first trained model may be used to determine a first response to the input query 624. In at least one embodiment, the first trained model is a general purpose model, such as a zero-shot model. A second trained model may be used to determine a second response to the input query 626. In at least one embodiment, the second trained model is a task specific model. The first and second responses may both be trying to provide a same or similar response, for example, determining a label associated with a class of the input query.

Various embodiments may include determining an agreement between the first and second responses 628. Agreement may refer to an amount of similarity between the first and second responses. In at least one embodiment, agreement is evaluated against a threshold, such as level of similarity between a particular response, a set of responses, responses over time, and the like. In at least one embodiment, agreement may correspond to identifying a same or similar label. It may be determined whether the agreement exceeds a threshold 630. If so, the second model may be verified 632, which may lead to full deployment of the second model and ceasing operation of the first model. If not, the second model may be re-trained 634. In this manner, a second model, which may be less computationally intensive, can be compared to a more computationally intensive first model to determine if the second model can effectively replace the operation of the first model, thereby decreasing operating costs while also increasing a number of applications for the system due to the utilizing a less computationally expensive model.

The systems and methods described herein may be used for a variety of purposes, such as—by way of example and without limitation—for machine control, machine locomotion, machine driving, synthetic data generation, digital twinning, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Likewise, disclosed embodiments may be comprised in a variety of different systems such as retail kiosks or other consumer-interactive systems and devices, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation and digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Data Center

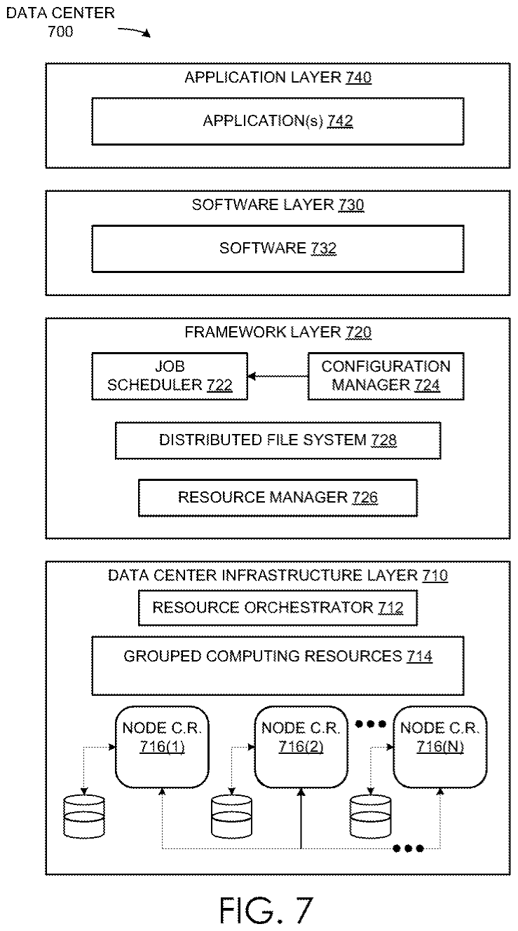

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used for executing commands in interaction environments.

### Computer Systems

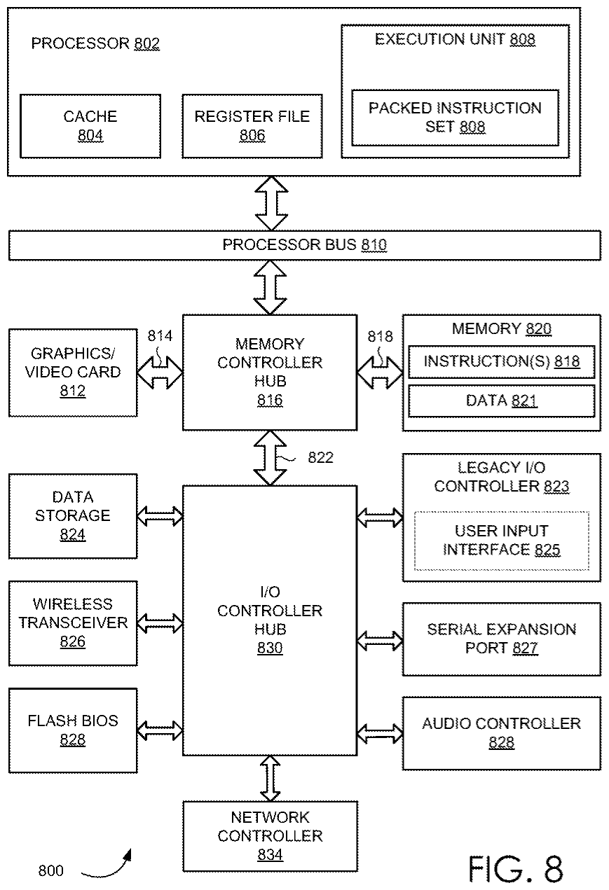

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), edge computing devices, set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components can be used for executing commands in interaction environments.

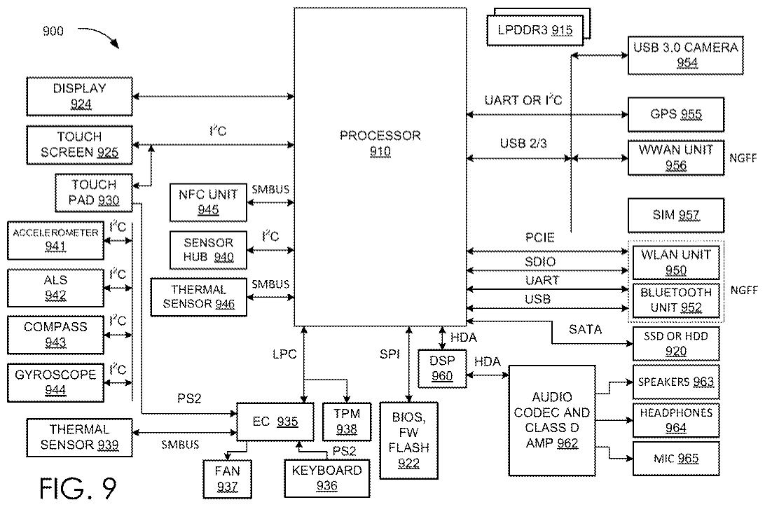

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 946, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used for executing commands in interaction environments.

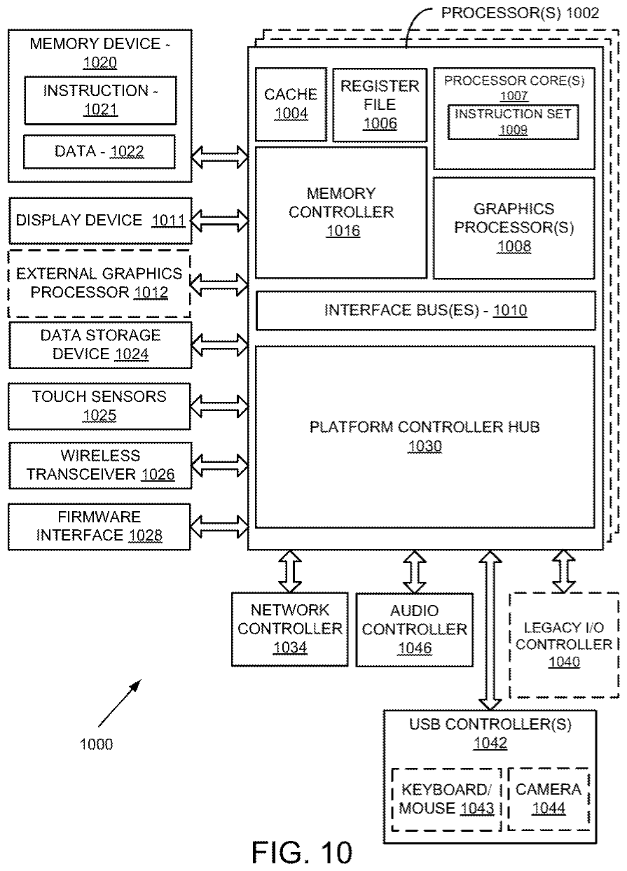

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system or datacenter having a large number of collectively or separably managed processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a cloud computing host platform, a virtualized computing platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, edge device, Internet of Things (“IoT”) device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used for executing commands in interaction environments.

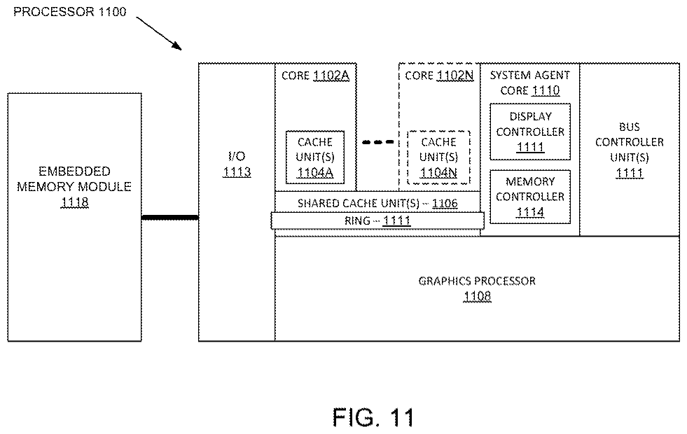

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used for executing commands in interaction environments.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, image signal processor (“ISP”), arithmetic logic unit (“ALU”), vision processing unit (“VPU”), tree traversal unit (“TTU”), ray tracing core, tensor tracing core, tensor processing unit (“TPU”), embedded control unit (“ECU”), and the like. As non-limiting examples, “processor” may be a hardware accelerator, such as a PVA (programmable vision accelerator), DLA (deep learning accelerator), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processors to:
receive one or more parameters associated with a first model, the one or more parameters including one or more classes;
receive one or more first queries for the first model, the first model trained to respond to queries associated with the one or more classes;
train a second model using the one or more first queries and respective responses from the first model; and
receive one or more second queries for the trained second model, the trained second model to respond to the one or more second queries associated with the one or more classes; and
store the queries and respective responses using a data store.

2. The system of claim 1, wherein the first model is a zero-shot model.

3. The system of claim 1, wherein the one or more parameters include, at least in part, natural language descriptions of the one or more classes.

4. The system of claim 1, wherein the second model is at least partially operational in parallel with the first model.

5. The system of claim 1, wherein the one or more processors are further to:
determine an alignment between responses of the first model and responses of the second model; and
determine the alignment exceeds a threshold.

6. The system of claim 5, wherein the first model ceases receiving the one or more first queries after the threshold is reached.

7. The system of claim 1, wherein the one or more processors are further to:
determine a number of queries and respective response within the data store exceeds a training threshold.

8. The system of claim 1, wherein the second model is trained at least partially in parallel with operation of the first model.

9. The system of claim 1, wherein the respective responses include respective labels corresponding to the one or more classes.

10. A method, comprising:
receiving class parameters for a first machine learning model;
receiving a query;
processing the query using the first machine learning model according to the class parameters;
providing a response to the query;
storing the query and the response as a query/response pair; and
providing, to a second machine learning model, the query/response pair as training data.

11. The method of claim 10, wherein the class parameters include at least natural language descriptions of one or more classes for a classifier.

12. The method of claim 10, further comprising:
receiving a second query;
processing the second query using both the first machine learning model and the second machine learning model;
comparing a first response from the first machine learning model to a second response from the second machine learning model; and
determining a convergence value between the first response and the second response.

13. The method of claim 12, further comprising:
determining the convergence value exceeds a threshold; and
ending operation of the first machine learning model.

14. The method of claim 10, wherein the response to the query corresponds to a label, the method further comprising:
determining an action associated with the label; and
executing the action.

15. The method of claim 10, further comprising:
compressing the second machine learning model; and
deploying the second machine learning model to execute on an edge server.

16. The method of claim 10, further comprising:
receiving a plurality of queries;
generating a plurality of query/result pairs;
determining a number of query/result pairs exceeds a threshold; and
scheduling a training session for the second machine learning model.

17. A system, comprising:
an input platform to receive one or more parameters for a first model;
a second model, different from the first model, the second model to generate a response to one or more inference quests using at least the one or more parameters;
a query interface to receive queries, the query interface directing queries to the second model; and
a training platform to provide, to the first model, at least a portion of the queries and respective responses as training data.

18. The system claim 17, wherein the query interface directs queries to both the first model and the second model.

19. The system of claim 18, further comprising:
an evaluation platform to compare responses from the first model and responses from the second model, the evaluation platform determining an agreement between the responses from the first model and the responses from the second model.

20. The system of claim 17, wherein the second model is a zero shot model.

21. The system of claim 17, wherein the system is comprised in at least one of:
a control system for an autonomous or semi-autonomous machine;
a conversational AI system;
a perception system for an autonomous or semi-autonomous machine;
a system for performing simulation operations;
a system for collaborative content creation;
a system for performing deep learning operations;
a system implemented using an edge device;
a system implemented using a robot;
a system for generating synthetic data;
a system incorporating one or more virtual machines (VMs);
a system implemented at least partially in a data center; or
a system implemented at least partially using cloud computing resources.
